(19) United States
(12) Patent Application Publication
(10) Pub. No.: US 2009/0138189 A1
(43) Pub. Date: May 28, 2009

(54) Terminal for collecting traffic information and method of generating traffic information

(75) Inventors: Tae Soo Kim, Gyeonggi-do (KR); Young Eon Ma, Yongin-Si (KR); Seong Ryong Kim, Gangbuk-Gu (KR); Ji Hye Kim, Mapo-Gu (KR); Hyeong Rae Cho, Jungnang-Gu (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/082,358

(22) Filed: Apr. 9, 2008

(30) Foreign Application Priority Data
Nov. 28, 2007 (KR) 10-2007-0122088

(51) Int. Cl. G08G 1/00

(52) U.S. Cl. 701/117

(57) ABSTRACT

The present invention provides a terminal for collecting traffic information generates a data set, including information about a measurement start point and a travel locus, periodically measured for a predetermined period from the start point, using DR information based on DR and GPS information, and transmits the data set to a remote traffic information center. The start point includes a vehicle ID, and absolute coordinates and an absolute time at the start point, and the travel locus information includes relative coordinates of each measurement location with respect to a previous measurement location. A method for generating traffic information in a remote traffic information center using information collected from the terminal is also provided. Accordingly, the present invention can reduce the amount of data provided by the terminal to the remote traffic information center, and can generate high-precision traffic information even in an area in which the reception of GPS signals is not possible and GPS signals are weak.

### CROSS-REFERENCE TO RELATED APPLICATIONS

This application claims priority to Korean Application No. 10-2007-0122088, filed on Nov. 28, 2007, the disclosure of which is incorporated herein by reference.

### BACKGROUND

1. Technical Field

The present invention relates to a terminal for collecting traffic information, which is installed in a vehicle, and a method of generating or processing traffic information in a remote traffic information center using source data collected from the terminal.

2. Background Art

Recently, in order to relieve traffic congestion or traffic jams on roads, technology for providing road traffic information to drivers in real time has been developed.

The provision of traffic information is implemented in such a way that information about the locations of vehicles is obtained from a plurality of vehicles, each equipped with a terminal for collecting traffic information, and that a remote traffic information center generates traffic information based on the collected information and provides the traffic information to the drivers.

In order to generate traffic information in which actual traffic conditions of roads are taken into consideration, location information must be obtained in real time from a plurality of vehicles, each equipped with such a terminal. However, in this case, there is a problem in that the amount of data transmitted over a wireless communication network increases, thus increasing costs.

Further, a standard Global Positioning System (GPS) is used to acquire information about the locations of vehicles. However, the standard GPS is problematic in that, in the case of areas such as tunnels, in which the tracking of locations using GPS is not possible, it is impossible to collect the traffic information in such areas, and in the case of areas, such as a downtown area, in which GPS signals are weak, the traffic information of the area is not precise.

Further, the velocity in a specific link is typically obtained from the velocity of a vehicle traveling between nodes using the same method. However, there are various factors influencing the speed in a link, for example, the travel directions of vehicles, and a queue of waiting vehicles. Therefore, a method of generating traffic information in which such detailed road conditions can be considered is required.

The information disclosed in this Background section is only for enhancement of understanding of the background of the invention and should not be taken as an acknowledgement or any form of suggestion that this information forms the prior art that is already known to a person skilled in the art.

### SUMMARY OF THE DISCLOSURE

Accordingly, the present invention has been made keeping in mind the above problems occurring in the prior art, and an object of the present invention is to provide a terminal for collecting traffic information and a method of generating traffic information, which can reduce the amount of data transmitted from the terminal to a remote traffic information center.

Another object of the present invention is to provide a terminal for collecting traffic information and a method of generating traffic information, which can obtain the precise travel locus of a vehicle even in an area in which the reception of GPS signals is not possible, or in which GPS signals are weak, and can generate traffic information on the basis of the travel locus.

A further object of the present invention is to provide a method of generating traffic information, in which detailed traffic conditions of roads, such as the travel directions of vehicles or a queue of waiting vehicles, are considered.

In order to accomplish the above objects, one aspect of the present invention provides a terminal for collecting traffic information, comprising a Global Positioning System (GPS) unit, a Dead Reckoning (DR) unit, an information generation unit and a transmission unit. The GPS unit receives GPS signals from at least one satellite to obtain absolute GPS coordinates and generate relative GPS coordinates from the absolute GPS coordinates. The DR unit receives signals from a direction sensor and a velocity sensor and calculates relative coordinates based on DR. The information generation unit generates, using data received from the GPS reception unit and the DR unit, a data set including information about a measurement start point and a travel locus, periodically measured for a predetermined period from the start point. The start point information includes a vehicle ID, and absolute coordinates and an absolute time at the start point. The travel locus information includes relative coordinates of each measurement location with respect to a previous measurement location. The transmission unit periodically transmits the data set generated by the information generation unit to a remote traffic information center over a wireless communication network.

Preferably, the information generation unit comprises a Dilution of Precision (DOP) correction module for obtaining primary relative coordinates by differently applying consideration rates of the relative GPS coordinates and the relative DR coordinates, and for calculating primary absolute coordinates from the primary relative coordinates.

Preferably, the information generation unit may further comprise: a map storage module for storing an electronic map therein; a map matching module for obtaining secondary absolute coordinates from the primary absolute coordinates through map matching, and obtaining secondary relative coordinates from the secondary absolute coordinates; and a data storage module for storing data generated by at least the map matching module. Suitably, the absolute coordinates of the start point can be implemented using the secondary absolute coordinates, and the relative coordinates of the travel locus can be implemented using the secondary relative coordinates.

Preferably, the travel locus information, grouped into the data set, may include a relative time or a sequence.

Another aspect of the present invention provides a method of generating traffic information in a remote traffic information center using information about a travel locus of a vehicle, collected from the above-described terminal over a wireless communication network.

Preferably, the method comprises: periodically receiving a data set including information about a measurement start point and a travel locus, periodically measured for a predetermined period from the start point, wherein the start point information includes a vehicle ID, and absolute coordinates and an absolute time at the start point, and the travel locus information includes relative coordinates of each measurement location with respect to a previous measurement location; generating traffic flow information for each link by processing the data set received from the terminal; and adding road accident information to the traffic flow information for each link, thus generating traffic information.

Preferably, the relative coordinates of the travel locus are generated by performing a process comprising: obtaining primary relative coordinates by differently applying consideration rates of relative GPS coordinates and relative DR coordinates; obtaining primary absolute coordinates from the primary relative coordinates; obtaining secondary absolute coordinates from the primary absolute coordinates through map matching; and calculating secondary relative coordinates with respect to a previous measurement location using the secondary absolute coordinates.

Suitably, the absolute coordinates of the start point are corrected absolute coordinates, obtained through map matching of the absolute coordinates received from a GPS reception unit, and the relative coordinates of the travel locus are the secondary relative coordinates.

Preferably, the generating traffic flow information for each link is performed such that, when a vehicle entering a target link, for which it is desired to generate traffic information, is a left-turning or right-turning vehicle, a velocity in a section of a queue of waiting vehicles, intending to enter the target link from a link previous to the target link, is taken into account in a velocity in the target link.

Also suitably, the generating traffic flow information for each link is performed such that, when a vehicle leaving a target link, for which it is desired to generate traffic information, is a left-turning or right-turning vehicle, a velocity in a section of a queue of waiting vehicles, intending to enter a link subsequent to the target link from the target link, is not taken into account in a velocity in the target link.

Preferably, the generating traffic flow information for each link may further comprise calculating a length of a queue of waiting vehicles in a link or a node using vehicle locus information obtained from the terminal.

Preferably, the absolute coordinates of the start point are implemented using the secondary absolute coordinates, and the relative coordinates of the travel locus are implemented using the secondary relative coordinates. Further, the travel locus information, grouped into the data set, may include a relative time or a sequence.

Meanwhile, a node passing time of the vehicle required to calculate the velocity of the vehicle in a link may be calculated using a distance between two locations, obtained from information about coordinates of the two locations measured immediately before and after the vehicle passes through the node. In this case, the link may be a partition obtained by dividing a street or a freeway with respect to any one direction, and a node generally denotes a crossing connected to two or more links.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a conceptual view showing a system for implementing a method of generating traffic information according to an embodiment of the present invention;

FIG. 2 is a diagram showing the construction of the traffic information collection terminal of FIG. 1;

FIG. 3 is a diagram showing a data transmission unit (data set) according to an embodiment of the present invention;

FIG. 4 is a diagram showing the configuration of a data set according to an embodiment of the present invention;

FIG. 5 is a diagram showing a process for generating a data set according to an embodiment of the present invention;

FIG. 6 is a diagram showing a method of calculating a node passing time according to an embodiment of the present invention;

FIG. 7 is a diagram showing a method of calculating a link speed according to an embodiment of the present invention; and

FIGS. 8 and 9 are diagrams showing a method of generating traffic information for each link according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

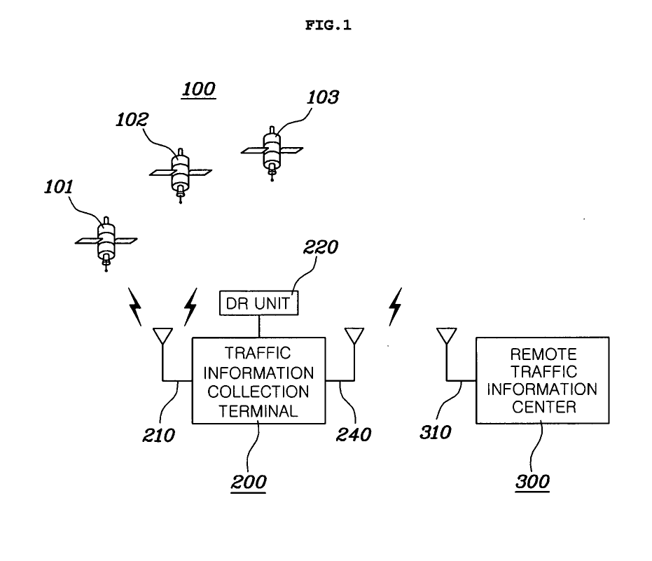

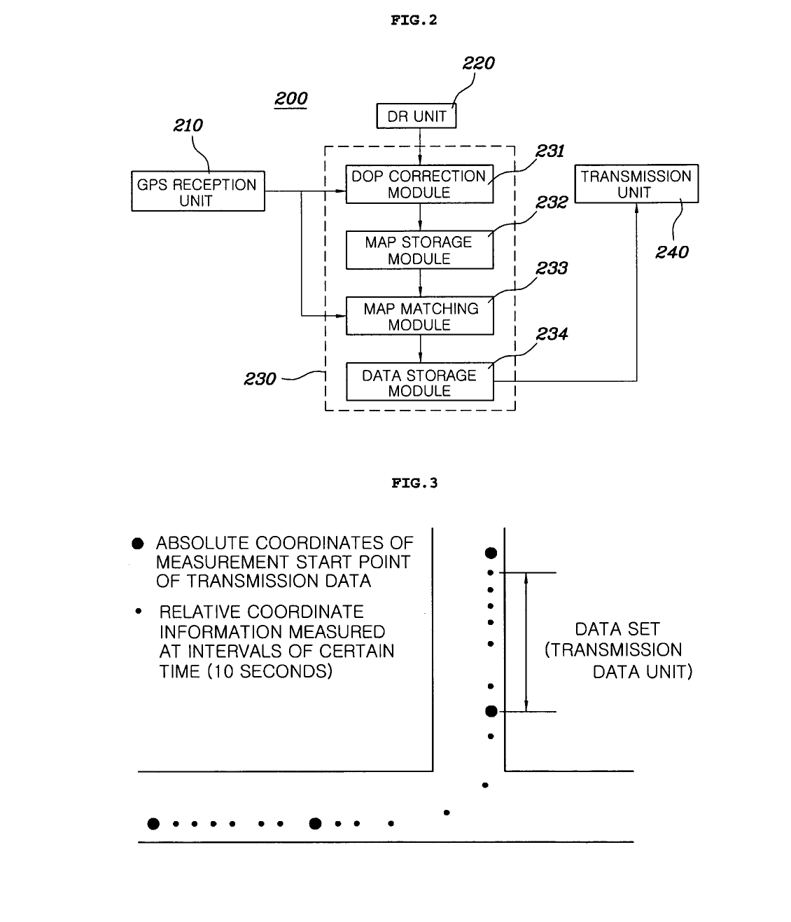

With reference to FIGS. 1 and 2, a terminal 200 installed in a vehicle is described.

As shown in FIG. 1, the terminal 200 generates information about the location of a vehicle using GPS signals received from satellites 100 and Dead Reckoning (DR) data obtained through DR, and periodically provides the location information to a remote traffic information center 300 over a wireless communication network.

As shown in FIG. 2, the terminal 200 includes a GPS reception unit 210, a DR unit 220, an information generation unit 230, and a transmission unit 240.

The GPS reception unit 210 receives the location information about the vehicle from the satellites through an antenna, converts the received information into a digital format, tracks the satellites, and thus updates the location information about the vehicle. The GPS reception unit 210 obtains information about the current coordinates of the vehicle and the current time, which are provided as the absolute values thereof.

The DR unit 220 is a sensor-based device using the principles of inertial navigation or dead reckoning, and is configured to receive signals from a direction sensor and a velocity sensor and to calculate relative coordinates, for example. A gyro sensor is used as the direction sensor, and a wheel sensor, a speed sensor, or an acceleration sensor, for instance, can be used as the velocity sensor.

The precision of the GPS signals received from the satellites 100 is influenced by the geometric arrangement of the satellites 101, 102 and 103 around the GPS reception unit 210. Therefore, the GPS signals must be corrected in order to improve the precision thereof. Such correction is performed by the information generation unit 230 using the relative DR coordinates and map matching technology.

The information generation unit 230 includes a DOP correction module 231, a map storage module 232, a map matching module 233, and a data storage module 234.

The DOP correction module 231 obtains corrected relative coordinates (primary relative coordinates) by differently applying the consideration rates of the relative GPS coordinates, which are obtained from the absolute GPS coordinates, and the relative DR coordinates, on the basis of the DOP of the GPS, and calculates corrected absolute coordinates (primary absolute coordinates) from the primary relative coordinates.

The DOP, a coefficient for indicating the geometric strength of satellite configuration on GPS positioning accuracy, indicates high precision as the value thereof is low. The generation of the vehicle location information is performed in such a way as to increase the consideration rate of GPS coordinates in a section having a low DOP, and to increase the consideration rate of DR coordinates in a section having a high DOP. The consideration rates of GPS and DR coordinates based on DOP can be set, as shown in the following Table 1.

TABLE 1

| | GPS consideration | |
|---|---|---|
| DOP | rate | DR consideration rate |
| ~2 | 1.0 | 0.0 |
| 2~3 | 0.9 | 0.1 |
| 3~4 | 0.7 | 0.3 |
| 4~5 | 0.3 | 0.7 |
| 5~6 | 0.1 | 0.9 |
| 6~reception | 0 | 1.0 |
| impossible | | |

Further, the current location of the vehicle can be calculated as the relative coordinates using the following Equation [1].

relative coordinates=relative GPS coordinates×GPS consideration rate+relative DR coordinates×DR consideration rate [1]

The location information primarily corrected by the DOP correction module 231 in this way may, preferably, be further corrected using map matching technology.

The map storage module 232 of the information generation unit 230 includes an electronic map therein, and the map matching module 233 obtains secondarily corrected absolute coordinates (secondary absolute coordinates) by matching the primary absolute coordinates with the electronic map, and calculates relative coordinates (secondary relative coordinates) from the secondary absolute coordinates.

The data storage module 234 of the information generation unit 230 stores therein the data generated by the information generation unit 230, in particular, the map matching module 233.

The transmission unit 240 transmits the data stored in the data storage module 234 to the remote traffic information center 300. The remote traffic information center 300 generates traffic information using the vehicle location information obtained from the terminal 200 and other types of road information.

Meanwhile, the term ‘module’ used in the present invention means a software or hardware component, which performs specific functions. However, the module is not limited to software or hardware. For example, the module may include software components, processors, functions, attributes, procedures, subroutines, segments of program code, drivers, firmware, microcode, circuits, data, databases, data structures, tables, queues, and variables. The functions provided by the components and the modules may be combined into a small number of components and modules, or may be further divided into additional components and modules.

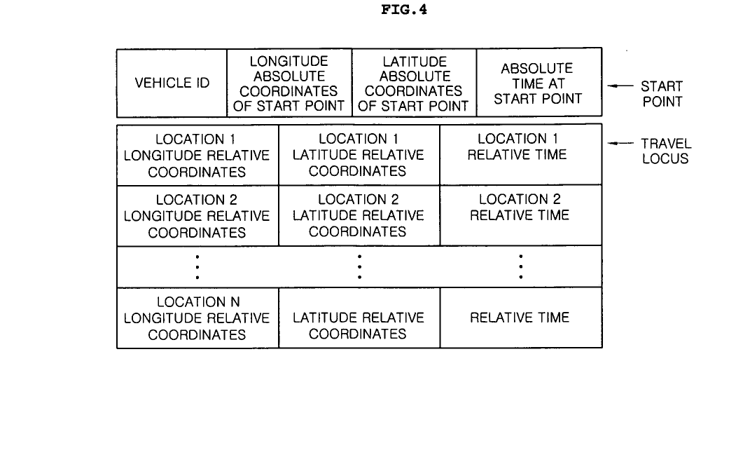

With reference to FIGS. 3 to 8, a method of generating traffic information using the above-described terminal 200 is described. The functions provided by respective components of the terminal 200 are described in detail below.

As shown in FIG. 3, the location information about the vehicle generated by the terminal is grouped into a data set, and is periodically transmitted to the remote traffic information center. A single data set includes information about a measurement start point and a travel locus, which is periodically measured for a predetermined period from the start point. For example, the data set may be configured to include one pair of absolute coordinates of the measurement start point for the transmitted data set, and six pairs of relative coordinates measured at intervals of 10 seconds for 1 minute.

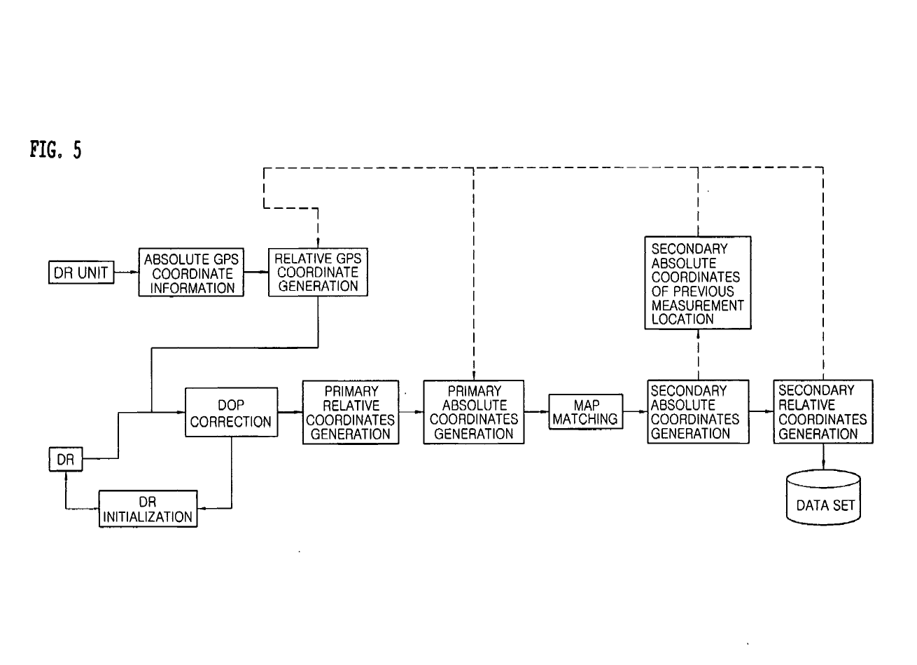

As shown in FIG. 4, the start point information of the data set includes a vehicle ID, the absolute coordinates of the start point (longitude and latitude absolute coordinates) and an absolute time, and the travel locus information includes the relative coordinates of each measurement location with respect to a previous measurement location (longitude and latitude relative coordinates) and a relative time. When data is transmitted based on the absolute coordinates and the absolute time, 4 bytes are required for the absolute coordinates and the absolute time, respectively, but, in the case of relative coordinates, only 2 bytes for the absolute coordinates and 1 byte for the absolute time are required. Therefore, when the unit set of data transmitted from the terminal to the remote traffic information center is configured, as shown in FIG. 4, the size of data can be reduced.

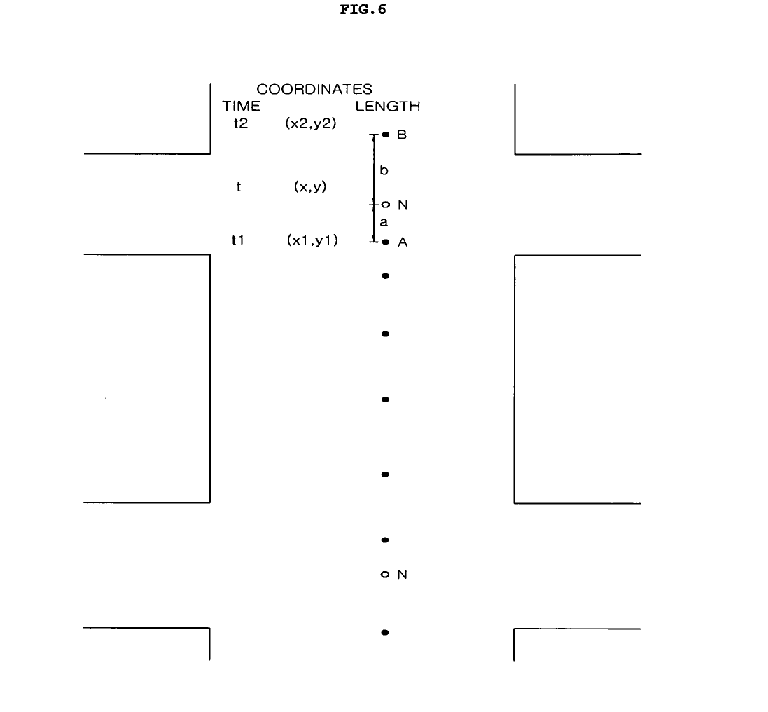

With reference to FIG. 5 together with the above drawings, a process in which the terminal 200 generates a data set is described.

The GPS reception unit 210 of the terminal 200 receives GPS signals from the satellites 100, obtains absolute GPS coordinates, and generates relative GPS coordinates from the absolute GPS coordinates. For the generation of relative GPS coordinates, the secondary absolute coordinates of the previous measurement location, stored in the data storage module 234, are used. Of course, the absolute GPS coordinates of the previous measurement location may be, alternatively, used.

The DR unit 220 calculates the relative location of the vehicle with respect to the previous measurement location using the signals received from the direction sensor and the velocity sensor installed in the vehicle. The relative coordinates calculated by the DR unit 220 may have an increasing error as the travel distance of the vehicle increases, and thus DR data must be initialized after the calculation of each pair of relative coordinates, or periodically.

The DOP correction module 231 of the information generation unit 230 generates primary relative coordinates by applying the relative GPS coordinates, relative DR coordinates and GPS DOP of the current location of the vehicle to Equation [1].

The map matching module 233 corrects the primary coordinates generated by the DOP correction module 231 to secondary relative coordinates through map matching. The primary absolute coordinates are corrected to secondary absolute coordinates through map matching, and the secondary absolute coordinates are converted into secondary relative coordinates. The secondary absolute coordinates of the previous measurement location, stored in the data storage module 234, are used to generate the primary and secondary absolute coordinates and the secondary relative coordinates.

As described above, the data generated by the information generation unit 230, in particular, the secondary relative coordinates, in which the travel locus of the vehicle is considered, are stored in the data storage module 234, and are grouped into a data set. The start point information of the data set includes absolute coordinates, especially secondary absolute coordinates. Of source, the corrected absolute coordinates, obtained through the map matching of the absolute coordinates received from the GPS reception unit 210, can be used as the absolute coordinates used in the start point information of the data set initially generated by the terminal 200.

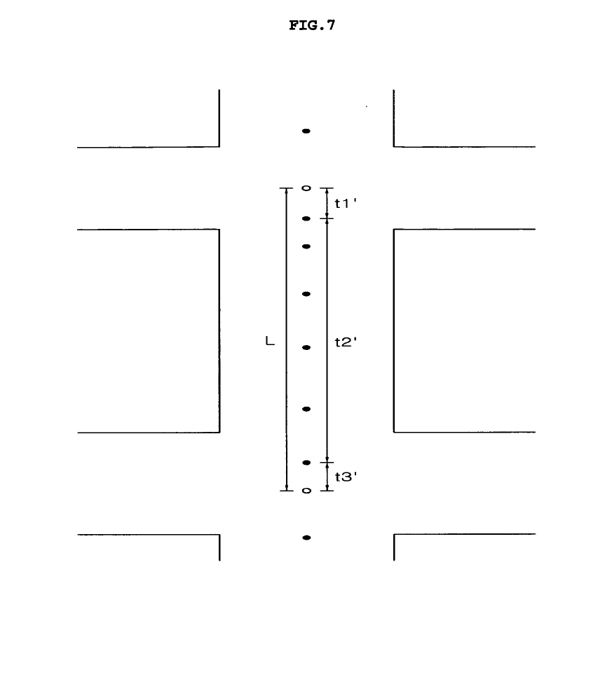

When the data set generated in this way is used, the time at which the vehicle passes through a node on the road can be precisely calculated. The method of calculating the time is described below with reference to FIG. 6.

The time t at which the vehicle passes through a node N can be calculated using information about coordinates and times (x1, y1, t1) and (x2, y2, t2) respectively measured at two locations A and B immediately before and after the vehicle passes the node N, and information about the coordinates (x, y) at the node N. For example, when it is assumed that the travel locus points of the vehicle are generated at intervals of 10 seconds, and a data set for the vehicle travel locus points is generated at intervals of 1 minute and is transmitted to the remote traffic information center, the following Equations can be derived:

t2=t1+10(sec) [2]

a=\sqrt{(x−x1)²+(y−y1)²} [3]

b=\sqrt{(x2−x)²+(y2−y)²} [4]

where x, x1, x2, y, y1, y2, t1, and t2 are absolute values.

Further, when it is assumed that the vehicle moves between locations A and B at a uniform velocity, the following Equation [5] is derived:

t=t1+(t2−t1)×a/(a+b)=t1+10×a/(a+b) [5]

where t is the absolute time.

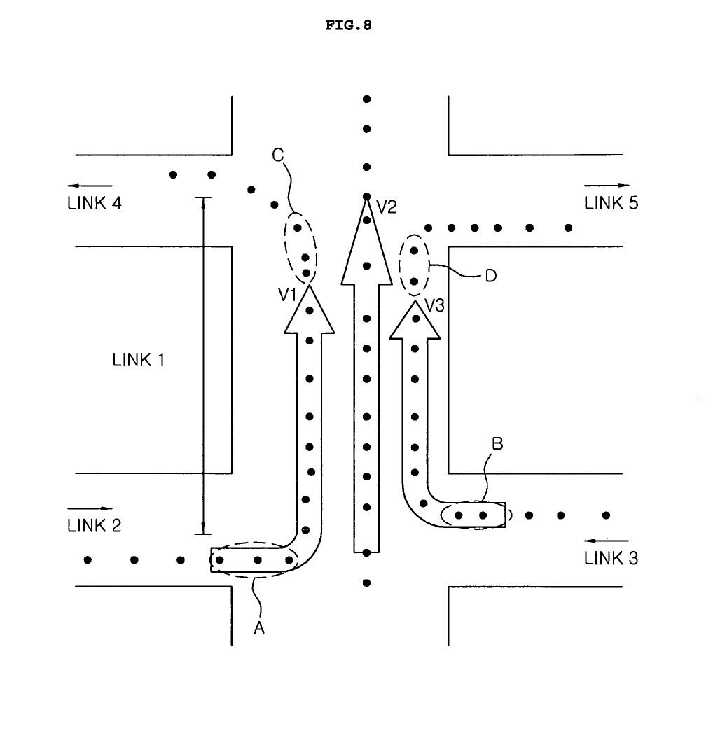

With reference to FIG. 7, a method of calculating a link velocity on a road is described.

When it is assumed that the length of a link is L, and the total time required to pass through the link is t1′+t2′+t3′, t2′ is 50 seconds (i.e., the number of vehicle locus points is 5). t1′ and t2′ can be obtained using the above-described node passing time calculation method. Therefore, the link velocity can be obtained using the following Equation [6].

v=L/(t1′+t2′+t3′) [6]

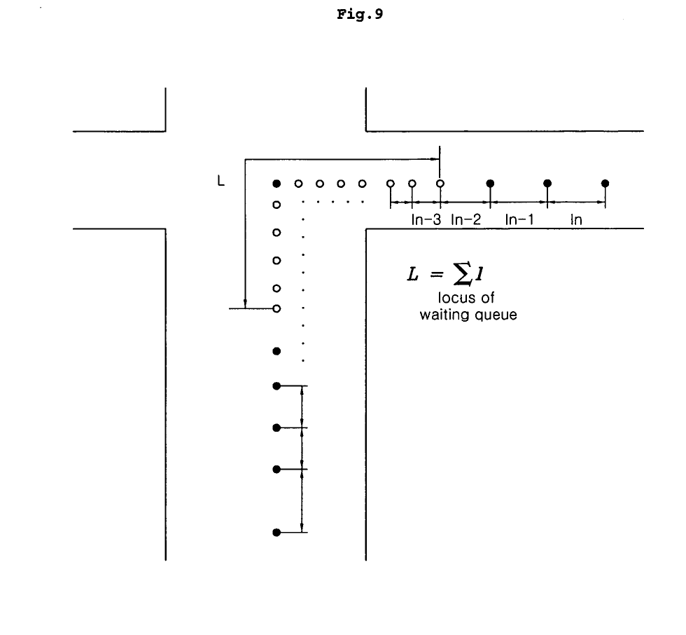

As described above, the travel locus points of the vehicle are generated at regular intervals, for example, 10 seconds, so that the remote traffic information center can more precisely detect the movement of the vehicle traveling along the road. For example, as shown in FIG. 8, the velocity of the vehicle passing through a target link, for which it is desired to generate traffic information, can also be calculated for each traveling direction of a vehicle. That is, the velocities of a vehicle turning left, a vehicle traveling straight, and a vehicle turning right can be obtained as v1, v2 and v3, respectively, and the velocity v of the vehicles in the link 1 can be obtained as the average value thereof, that is, v1+v2+v3/3.

Meanwhile, typically, a velocity in a link is obtained by simply measuring the velocity of a vehicle that travels between respective nodes. This applies to the case of a vehicle traveling straight. However, according to an embodiment, in order to generate traffic information for the target link, detailed road conditions, such as the travel directions of vehicles, and a queue of waiting vehicles, are taken into consideration. That is, as shown in FIG. 8, the flow of vehicles which enter a link 1 after turning left (or right) at a link 2 (or a link 3) forms a waiting queue A (or B) near a crossing. Such a waiting queue A or B depends on a traffic flow in the link 1, and also influences the velocity in the link 1. Therefore, the velocity in a section of the waiting queue is taken into account at the time of calculating the velocity in the link 1.

Further, the flow of vehicles which enter a link 4 or 5 after turning left or right at the link 1 forms a waiting queue C or D near a crossing. The velocity in a section of the waiting queue is taken into account at the time of calculating the velocity in the link 4 or 5, but is not taken into account at the time of calculating the velocity in the link 1. The length of the above-described waiting queue section may be set to a preset value (default), or may be the length of an actual waiting queue of vehicles traveling at a velocity below a certain velocity in consideration of the flow of vehicles.

With reference to FIG. 9, the calculation of the length of a waiting queue is described.

Information about the length of a waiting queue is useful, especially for a road user passing through a crossing, a ramp, a toll gate, etc. A place requiring the calculation of the length of a waiting queue is defined in node or link data. The remote traffic information center determines whether the calculation of the length of a waiting queue is required according to the traffic conditions, and calculates the length of a waiting queue in a given node or link if it is determined that the calculation of the length of the waiting queue is required.

The length of a waiting queue can be calculated on the basis of the vehicle locus information of the data set received from the terminal. For example, in the case where a waiting queue of traveling vehicles is formed by vehicles turning right at a crossing, as shown in FIG. 9, a section L, in which the distances l1 to ln between the locus points of right-turning vehicles are equal to or less than a reference distance, is obtained, and thus the length of the waiting queue is calculated. When locus points are collected from the terminals at intervals of 10 seconds, and a vehicle, traveling slowly at a velocity below 5 km/h, is included in the waiting queue, the reference distance is calculated as, e.g., 2.7 m. Therefore, the start point and end point of the section, in which the distances between the locus points of right-turning vehicles are equal to or less than 2.7 m, are calculated, and the sum Σ1 of the distances between the locus points in the section is the length L of the waiting queue.

Meanwhile, the remote traffic information center generates integrated traffic information by adding road accident information to traffic flow information for each link obtained by the terminal, and provides the information to the road user.

As described above, the traffic information collection terminal and the traffic information generation method having the above construction can reduce the amount of data transmitted from the terminal to a remote traffic information center because most vehicle location information can be provided in the form of relative coordinates.

Further, the present invention is advantageous in that the inaccuracy of GPS can be compensated for using DR, thus enabling traffic information to be generated even in an area where the reception of GPS signals is not possible or where GPS signals are weak.

Further, the present invention is advantageous in that high-precision traffic information, in which the factors influencing velocity in links, for example, a waiting queue attributable to the travel directions of vehicles, are taken into consideration, can be generated.

Moreover, the present invention is advantageous in that the length of a waiting queue of vehicles, traveling more slowly than other surrounding vehicles, can be calculated and can be provided to a road user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A terminal for collecting traffic information, comprising:
a Global Positioning System (GPS) unit for receiving GPS signals from at least one satellite to obtain absolute GPS coordinates and generate relative GPS coordinates from the absolute GPS coordinates;
a Dead Reckoning (DR) unit for receiving signals from a direction sensor and a velocity sensor and calculating relative coordinates based on DR;
an information generation unit for generating, using data received from the GPS reception unit and the DR unit, a data set including information about a measurement start point and a travel locus, periodically measured for a predetermined period from the start point, wherein the start point information includes a vehicle ID, and absolute coordinates and an absolute time at the start point, and the travel locus information includes relative coordinates of each measurement location with respect to a previous measurement location; and
a transmission unit for periodically transmitting the data set generated by the information generation unit to a remote traffic information center over a wireless communication network.

2. The terminal according to claim 1, wherein the information generation unit comprises a Dilution of Precision (DOP) correction module for obtaining primary relative coordinates by differently applying consideration rates of the relative GPS coordinates and the relative DR coordinates, based on a DOP of the GPS unit, and for calculating primary absolute coordinates from the primary relative coordinates.

3. The terminal according to claim 2, wherein the information generation unit comprises:
a map storage module for storing an electronic map therein;
a map matching module for obtaining secondary absolute coordinates from the primary absolute coordinates through map matching, and obtaining secondary relative coordinates from the secondary absolute coordinates; and
a data storage module for storing data generated by at least the map matching module.

4. The terminal according to claim 3, wherein the absolute coordinates of the start point are implemented using the secondary absolute coordinates, and the relative coordinates of the travel locus are implemented using the secondary relative coordinates.

5. The terminal according to claim 1, wherein the travel locus information, grouped into the data set, includes a relative time or a sequence.

6. A method of generating traffic information in a remote traffic information center using information about a travel locus of a vehicle, collected from a terminal installed in the vehicle over a wireless communication network, comprising:
periodically receiving a data set including information about a measurement start point and a travel locus, periodically measured for a predetermined period from the start point, wherein the start point information includes a vehicle ID, and absolute coordinates and an absolute time at the start point, and the travel locus information includes relative coordinates of each measurement location with respect to a previous measurement location;
generating traffic flow information for each link by processing the data set received from the terminal; and
adding road accident information to the traffic flow information for each link, thus generating traffic information.

7. The method according to claim 6, wherein the relative coordinates of the travel locus are generated by performing a process comprising:
obtaining primary relative coordinates by differently applying consideration rates of relative GPS coordinates and relative DR coordinates;
obtaining primary absolute coordinates from the primary relative coordinates;
obtaining secondary absolute coordinates from the primary absolute coordinates through map matching; and
calculating secondary relative coordinates with respect to a previous measurement location using the secondary absolute coordinates.

8. The method according to claim 7, wherein the absolute coordinates of the start point are corrected absolute coordinates, obtained through map matching of the absolute coordinates received from a GPS reception unit, and the relative coordinates of the travel locus are the secondary relative coordinates.

9. The method according to claim 6, wherein the generating traffic flow information for each link is performed such that, when a vehicle entering a target link, for which it is desired to generate traffic information, is a left-turning or right-turning vehicle, a velocity in a section of a queue of waiting vehicles, intending to enter the target link from a link previous to the target link, is taken into account in a velocity in the target link.

10. The method according to claim 6, wherein the generating traffic flow information for each link is performed such that, when a vehicle leaving a target link, for which it is desired to generate traffic information, is a left-turning or right-turning vehicle, a velocity in a section of a queue of waiting vehicles, intending to enter a link subsequent to the target link from the target link, is not taken into account in a velocity in the target link.

11. The method according to claim 6, wherein the generating traffic flow information for each link comprises calculating a length of a queue of waiting vehicles in a link or a node using vehicle locus information obtained from the terminal.
